(19) United States
(12) Patent Application Publication
(10) Pub. No.: US 2026/0130499 A1
(43) Pub. Date: May 14, 2026

(54) WALL-MOUNTED ADJUSTABLE DESK FOR SOUNDPROOF BOOTH AND SOUNDPROOF BOOTH

(71) Applicant: FLEXISPOT INC., Irvine, CA (US)

(72) Inventors: Lehong XIANG, Irvine, CA (US); Tongwang SHAO, Irvine, CA (US); Zan ZHANG, Irvine, CA (US); Bo ZHANG, Irvine, CA (US); Jianzhao ZHANG, Irvine, CA (US); Yong MEI, Ningbo (CN)

(21) Appl. No.: 19/384,931

(22) Filed: Nov. 10, 2025

(30) Foreign Application Priority Data
Nov. 13, 2024 (CN) 202422757451.1
Mar. 14, 2025 (CN) 202520456836.6

(51) Int. Cl. A47B 9/04; A47B 5/00; E04H 1/12; G10K 11/16

(52) U.S. Cl. CPC A47B 9/04; A47B 5/00; E04H 1/125; G10K 11/16; A47B 2009/046

(57) ABSTRACT

A wall-mounted adjustable desk for a soundproof booth, includes a desk board, a linear driving mechanism mounted on a wall of the soundproof booth, and a supporting frame for the desk board. A soundproof booth includes the wall-mounted adjustable desk for a soundproof booth.

### CROSS-REFERENCE TO RELATED APPLICATIONS

This application claims priority to and claims the benefit of Chinese Patent Application No. 202520456836.6, filed on Mar. 14, 2025, and Chinese Patent Application No. 202422757451.1, filed on Nov. 13, 2024, which are hereby incorporated by reference in their entirety.

### TECHNICAL FIELD

The present application relates to the technical field of equipment for providing private space in public places, and in particular to a wall-mounted adjustable desk for soundproof booth and a soundproof booth.

### BACKGROUND

With the development of society and the increasing needs of people in work, life and communication, a soundproof booth placed in public places, business places or office areas, which can facilitate the user to think, work or express emotions, or facilitate the user to study, talk, hold meetings, make phone calls and communicate via video, has gradually been promoted and applied.

Generally, desks are essential facilities in soundproof booths. They were originally fixed desks, and later gradually developed into wall-mounted adjustable desks.

However, the prior art of wall-mounted adjustable desks in soundproof booths still has the following deficiencies. On the one hand, the adjustable desks are generally connected to the main body of the soundproof booth by only one lifting column, where the top of the lifting column is fixed to the middle of the desk board, and the bottom of the lifting column is fixed to the main body of the soundproof booth. The connection strength of such structure is insufficient. Specifically, the guidance, stability and reliability of the lifting of the desk board are insufficient. If the objects placed on the desk board are heavy, the raised nut of the lifting mechanism, which is at a distance from the bottom end of the screw thread of the lifting mechanism, may drop suddenly due to the overweight of the objects placed on the desk board. This will make the desk board drop suddenly, affecting the safety of use and the user experience. On the other hand, the lifting mechanisms are generally installed in the space inside the booth, making the operating noise relatively loud. Furthermore, because they are directly exposed to the space inside the booth, for safety and aesthetics, a sleeve for covering the outside of the lifting mechanism is necessary. In addition, the bottom end of the sleeve, which serves as the lifting column, may need to be fixed on the bottom plate of the soundproof booth, which also increases the length of the lifting column and relatively increases the material cost.

### SUMMARY

In the first aspect, the present application discloses a wall-mounted adjustable desk for a soundproof booth, including:
a desk board;
a linear driving mechanism mounted on a wall of the soundproof booth; and
a supporting frame for the desk board, wherein a moving member of the linear driving mechanism is connected to the supporting frame, the supporting frame is connected to the desk board, the supporting frame is provided with a first sleeving structure, and the wall of the soundproof booth is provided with a second sleeving structure slidably engaged with the first sleeving structure in a sleeving manner.

In some embodiments, at least two vertical plates respectively disposed at both sides of the supporting frame in a width direction are connected to a bottom of the desk board, and two first sleeving structures are disposed at both sides of the supporting frame, and two second sleeving structures are correspondingly disposed on the wall of the soundproof booth, each of the two first sleeving structures is one of a sliding sleeve or a guiding bar, and each of the two second sleeving structures is an other of the sliding sleeve or the guiding bar.

In some embodiments, the wall-mounted adjustable desk for the soundproof booth further including a first crossbar and a second crossbar disposed on the wall of the soundproof booth, where the first crossbar is configured to be connected to the linear driving mechanism, the first crossbar and the second crossbar are parallel to each other, the linear driving mechanism is configured to be connected to a middle of the first crossbar in a length direction of the first crossbar, bottom ends of the guiding bars are respectively connected to both ends of the first crossbar in the length direction of the first crossbar, top ends of the guiding bars are respectively connected to both ends of the second crossbar in a length direction of the second crossbar, and the two guiding bars are parallel to each other.

In some embodiments, the linear driving mechanism includes a nut-screw rod assembly, a motor and a gear box of the linear driving mechanism are mounted on a bottom of the first crossbar, an output shaft of the gear box passes through a hole of the first crossbar and is coaxially connected to a bottom end of a screw rod of the nut-screw rod assembly, a nut of the nut-screw rod assembly is connected to a bottom end of a supporting tube, and a part of the supporting tube is connected to a middle part of the supporting frame.

In some embodiments, a torsion spring self-locking assembly is provided at a lower end of the screw rod to prevent the desk board from descending when the motor stops and the nut is at a distance from a bottom end of a thread of the screw rod.

In some embodiments, a bearing is provided on the lower end of the screw rod and a bearing seat is provided on the first crossbar.

In the second aspect, the present application discloses a soundproof booth which includes a wall-mounted adjustable desk for a soundproof booth mentioned in any embodiments of the above first aspect. Furthermore, the soundproof booth further includes a soundproof door, a soundproof bottom panel, a soundproof top panel, and three soundproof side panels which are configured to form a rectangular soundproof booth body, at least one of the three soundproof side panels being configured to have a hollow structure;
where the soundproof side panel with the hollow structure serves as the wall of the soundproof booth, and the linear driving mechanism, the supporting frame, the first sleeving structure, and the second sleeving structure of the wall-mounted adjustable desk are mounted on the soundproof side panel with the hollow structure; and
where at least two first vertical elongated through holes are correspondingly formed on an inner plate of the hollow structure, the inner plate serves as an inner wall of the soundproof booth, the at least two vertical plates connected to the supporting frame pass through the at least first vertical elongated through holes in a one-to-one correspondence, and the at least two vertical plates are slidably fitted in the at least two first vertical elongated through holes respectively.

In some embodiments, two vertical rods disposed in the hollow structure are connected to a frame of the soundproof booth, and the first crossbar and the second crossbar are both connected to the two vertical rods; the soundproof booth further includes two elongated plates, two second vertical elongated through holes are respectively formed at the two elongated plates, and two vertical plates are slidably fitted in the two second vertical elongated through holes respectively, the two second vertical elongated through holes are aligned with the two first vertical elongated through holes respectively; each elongated plate includes a protruding strip having a same shape and a same size as the first vertical elongated through holes, two protruding strips of the two elongated plates are configured to be embedded in the two first vertical elongated through holes respectively.

In some embodiments, an elongated soundproof plate is slidably engaged in each second vertical elongated through hole, both side walls of each second vertical elongated through hole are provided with guiding grooves for a sliding of the elongated soundproof plate.

In some embodiments, the soundproof booth further including two L-shaped plates, where portions of the two vertical plates under the desk board are detachably connected to the two L-shaped plates, and the two L-shaped plates are fixed to a bottom surface of the desk board.

In the third aspect, the present application also provides a quick-assembly soundproof booth, including:
a bottom assembly;
two wall panel assemblies, including a first wall panel assembly and a second wall panel assembly, where lower ends of the two wall panel assemblies are respectively connected to the bottom assembly, and an upper end of the second wall panel assembly has a first mounting surface;
a top assembly, including a first connecting end and a second connecting end opposite to the first connecting end, where the first connecting end is rotatably connected to an upper end of the first wall panel assembly, and when the top assembly is rotated to a horizontal state relative to the first wall panel assembly, the second connecting end is configured to be matched with and connected to the first mounting surface and by a fastener(s) or adhesive material; where a matching surface shape between the second connecting end and the first mounting surface is an inclined surface shape, or a combined surface shape of a horizontal surface and an inclined surface, or a combined surface shape of a horizontal surface and an arcuate surface, or a stepped surface shape.

In some embodiments, a first connecting surface inclined relative to the first mounting surface is provided on an inner side of the first mounting surface, and the second connecting end has a second mounting surface and a second connecting surface inclined relative to the second mounting surface. When the top assembly is rotated to the horizontal state relative to the first wall panel assembly, the second mounting surface is configured to be matched with the first mounting surface and the second connecting surface is configured to be matched with the first connecting surface, and the first connecting surface and the second connecting surface are connected by a fastener(s).

In some embodiments, the upper end of the first wall panel assembly has a third mounting surface and a third connecting surface located on an inner side of the third mounting surface, and the third connecting surface is inclined relative to the third mounting surface. The first connecting end of the top assembly has a fourth mounting surface and a fourth connecting surface inclined relative to the fourth mounting surface. When the top assembly is rotated to the horizontal state, the fourth mounting surface is configured to be matched with the third mounting surface and the fourth connecting surface is configured to be matched with the third connecting surface, and the third connecting surface and the fourth connecting surface are connected by a fastener(s).

In some embodiments, a first connecting portion inclined toward a center of the top assembly is provided on the inner side of the upper end of each wall panel assembly along a length direction, and an outer side wall of the first connecting portion of the second wall panel assembly forms the first connecting surface, and an outer side wall of the first connecting portion of the first wall panel assembly forms the third connecting surface.

In some embodiments, the lower end of each wall panel assembly has a fifth mounting surface and a fifth connecting surface located on an inner side of the fifth mounting surface and inclined relative to the fifth mounting surface; two ends of the bottom assembly are respectively provided with two sixth mounting surfaces and two sixth connecting surface, the two sixth connecting surface respectively inclined relative to the corresponding two sixth mounting surfaces. When the lower ends of the two wall panel assemblies are connected to the bottom assembly, each fifth mounting surface is configured to be matched with the corresponding sixth mounting surface and each fifth connecting surface is configured to be matched with the corresponding sixth connecting surface, and each fifth connecting surface is connected to the sixth connecting surface by a fastener(s).

In some embodiments, a second connecting portion inclined toward a center of the bottom assembly is provided on the inner side of the lower end of each wall panel assembly along the length direction, and an outer side wall of the second connecting portion of each wall panel assembly forms the fifth connecting surface.

In some embodiments, the bottom assembly, the top assembly and the two wall panel assemblies are arranged to form a main booth body, a front side of the main booth body is connected to a ring-shaped front frame, and a rear side of the main booth body is connected to a ring-shaped rear frame, a booth door of the soundproof booth which is configured be opened or closed is connected to the front frame, and a back panel assembly is connected to the rear frame.

In some embodiments, connecting frames are respectively connected to a front side wall and a rear side wall of the main booth body, and the front frame and the rear frame are both provided with two plug-in slots along their circumferences. The plug-in slot on the front frame is configured to be plugged in and connected to the connecting frame connected to the front side wall of the main booth body, and the plug-in slot on the rear frame is configured to be plugged and connected to the connecting frame connected to the rear side wall of the main booth body.

In some embodiments, each connecting frame is provided with a mounting slot which is concave and extends along the length direction, and at least one inner side wall of each mounting slot is inclined to form a first mounting inclined surface. Two mounting members are respectively disposed in plug-in slots of the front frame and the rear frame, and the mounting slots and the mounting members are arranged correspondingly and configured to match each other. Each mounting member is provided with a second mounting inclined surface matching the first mounting inclined surface, and the first mounting inclined surface and the second mounting inclined surface are connected by a fastener(s).

In some embodiments, wheels are connected to a bottom of the bottom assembly.

Other features and advantages of the present application will become apparent from the following detailed description of exemplary embodiments of the present application with reference to the drawings.

### BRIEF DESCRIPTION OF DRAWINGS

FIG. 1 is a first schematic structural diagram of a wall-mounted adjustable desk of an implementation of the present application.

FIG. 2 is a second structural diagram of a wall-mounted adjustable desk of an implementation of the present application.

FIG. 3 is an enlarged structural diagram of portion A in FIG. 2.

FIG. 4 is an exploded diagram of some parts of the wall-mounted adjustable desk in FIG. 2.

FIG. 5 is an enlarged structural diagram of portion B in FIG. 4.

FIG. 6 is a schematic diagram of an external structure of a soundproof booth equipped with a wall-mounted adjustable desk of an implementation of the present application.

FIG. 7 is a schematic diagram of an internal structure of the soundproof booth equipped with a wall-mounted adjustable desk of FIG. 6 with a soundproof door omitted.

FIG. 8 is an enlarged structural diagram of portion C in FIG. 7.

FIG. 9 is an enlarged structural diagram of an elongated plate of an implementation of the present application.

FIG. 10 is an enlarged structural diagram of protruding strip of an implementation of the present application.

FIG. 11 is a schematic structural diagram of a quick-assembly soundproof booth according to some embodiments of the present application.

FIG. 12 is a schematic structural diagram of back view of a quick-assembly soundproof booth according to some embodiments of the present application.

FIG. 13 is a schematic cross-sectional view of a quick-assembly soundproof booth according to some embodiments of the present application.

FIG. 14 is an enlarged schematic structural diagram of portion D in FIG. 13.

FIG. 15 is an enlarged schematic structural diagram of portion E in FIG. 13.

FIG. 16 is an enlarged schematic structural diagram of portion F in FIG. 13.

FIG. 17 is a schematic structural diagram of a top assembly of a quick-assembly soundproof booth according to some embodiments of the present application.

FIG. 18 is a schematic structural diagram of a top assembly of a quick-assembly soundproof booth from another angle according to some embodiments of the present application.

FIG. 19 is a structural schematic diagram of a second wall assembly of a quick-assembly soundproof booth according to some embodiments of the present application.

FIG. 20 is a schematic structural diagram of a first wall assembly of a quick-assembly soundproof booth according to some embodiments of the present application.

FIG. 21 is a schematic structural diagram of a bottom assembly of a quick-assembly soundproof booth according to some embodiments of the present application.

FIG. 22 is a schematic diagram of an assembly structure of a quick-assembly soundproof booth according to some embodiments of the present application.

FIG. 23 is a schematic diagram of an assembly structure of a quick-assembly soundproof booth from another angle according to some embodiments of the present application.

FIG. 24 is a schematic diagram of an assembly structure of a main booth body of a quick-assembly soundproof booth according to some embodiments of the present application.

FIG. 25 is schematic diagrams of an assembly structure of a main booth body of a quick-assembly soundproof booth from another angle according to some embodiments of the present application.

FIG. 26 is a partial cross-sectional schematic diagram of a front frame of a quick-assembly soundproof booth according to some embodiments of the present application.

### DESCRIPTION OF EMBODIMENTS

Those skilled in the art should understand that the embodiments and the implementations are merely used to explain the technical principles of the technical solutions of the present application and are not intended to limit the scope of protection of the technical solutions of the present application. Those skilled in the art may adjust them as needed to suit specific application scenarios.

In the description of the embodiments of the present application, it should be noted that, unless otherwise specified or limited, the terms “connected” and “connection” should be understood in a broad sense. For example, they can refer to fixed connections, detachable connections, movable connections, or integral connections; they can refer to mechanical connections or electrical connections; they can refer to direct connections or indirect connections through an intermediate medium. Those skilled in the art will understand the specific meanings of the above terms in the embodiments of the present application based on the specific circumstances.

In the embodiments of the present application, unless otherwise expressly specified or limited, a first feature being “above” or “below” a second feature may mean that the first and second features can be in direct contact, or that the first and second features can be in indirect contact through an intermediate medium. Furthermore, a first feature being “above”, “on” and “over” a second feature may mean that the first feature is directly above or obliquely above the second feature, or may simply mean that the first feature is higher in level than the second feature. A first feature being “below”, “beneath” and “under” a second feature may mean that the first feature is directly below or obliquely below the second feature, or may simply mean that the first feature is lower in level than the second feature.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

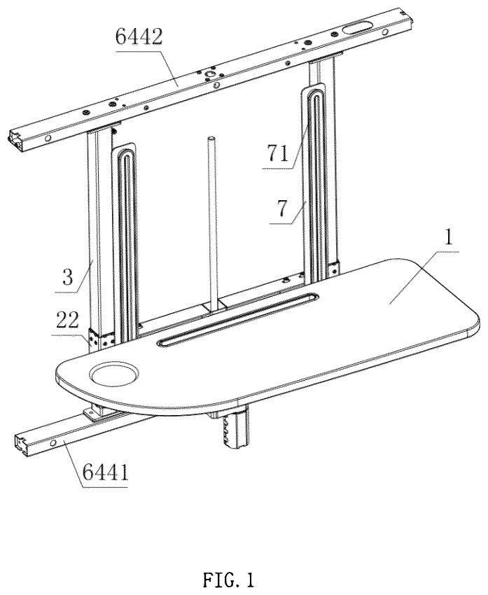

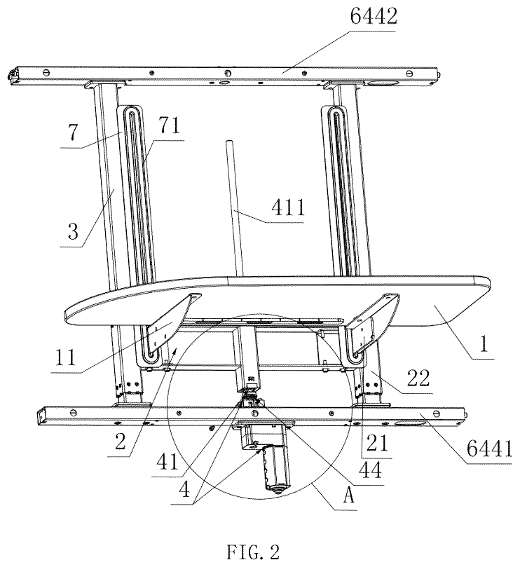

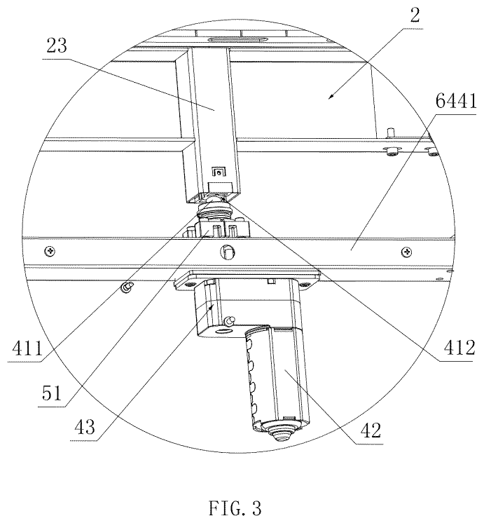

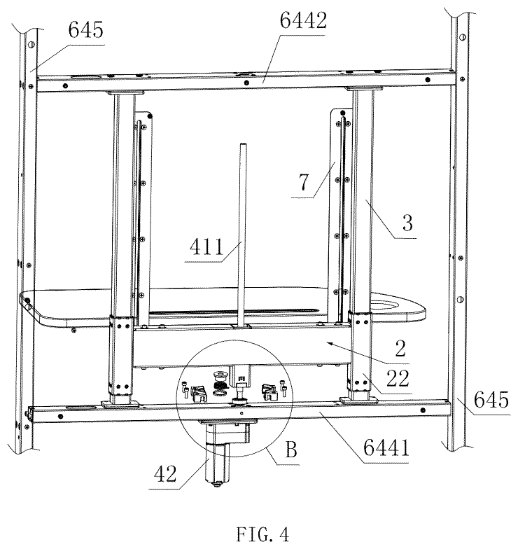

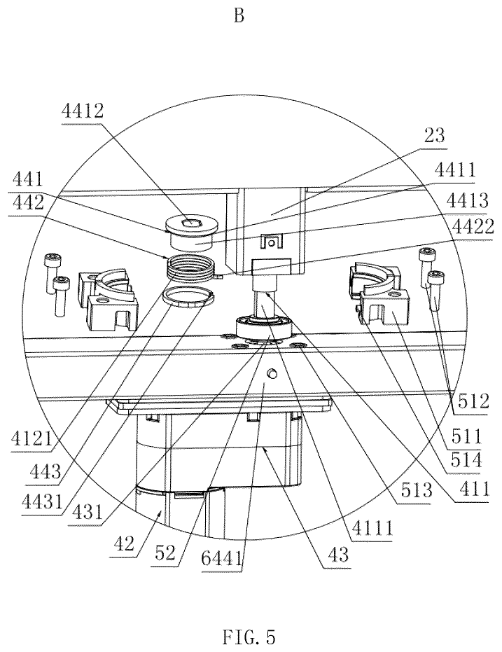

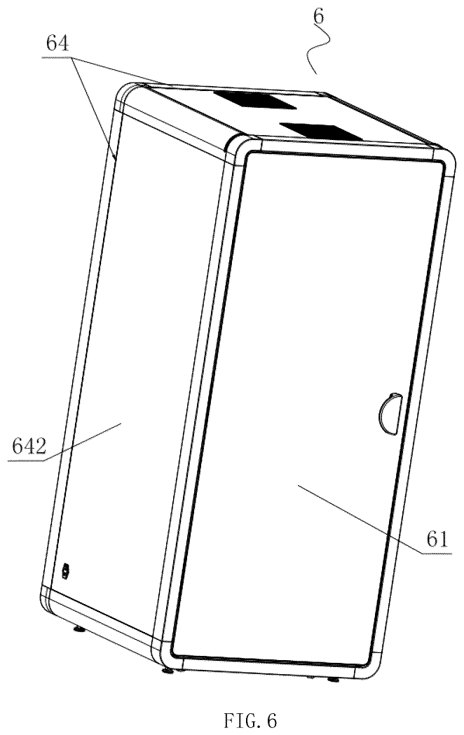

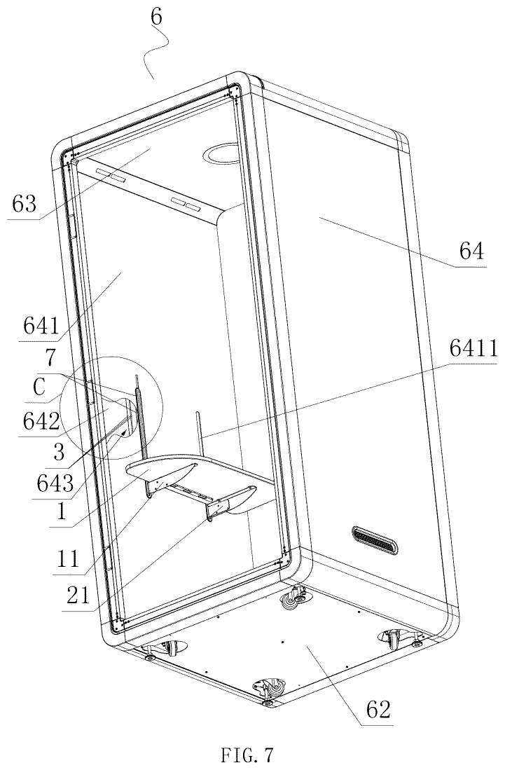

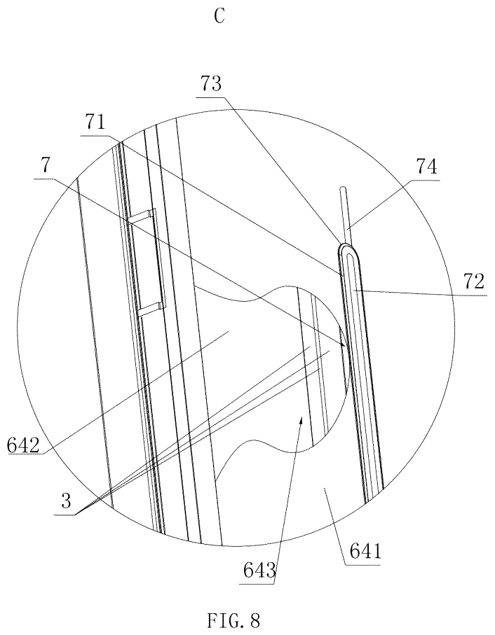

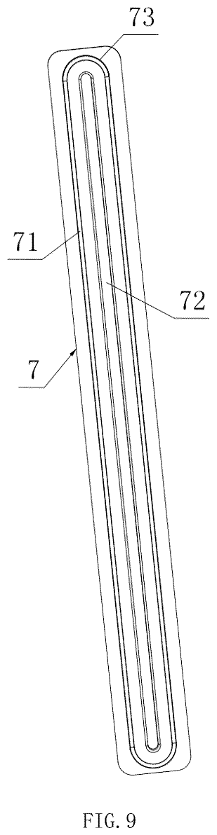

As shown in FIGS. 1-10, the present application discloses a wall-mounted adjustable desk for a soundproof booth and a soundproof booth.

The wall-mounted adjustable desk for a soundproof booth of the present application includes a desk board 1 and a linear driving mechanism 4 on a wall of the soundproof booth.

Furthermore, the wall-mounted adjustable desk further includes a supporting frame for the desk board, wherein a moving member of the linear driving mechanism is connected to the supporting frame, the supporting frame is connected to the desk board, the supporting frame is provided with a first sleeving structure, and the wall of the soundproof booth is provided with a second sleeving structure slidably engaged with the first sleeving structure in a sleeving manner. With such arrangements, the combination of the linear driving mechanism and the sleeving structure improves the moving guidance and stability of the desk board.

In some embodiments, at least two vertical plates respectively disposed at both sides of the supporting frame in a width direction are connected to a bottom of the desk board, and two first sleeving structures are disposed at both sides of the supporting frame, and two second sleeving structure are correspondingly disposed on the wall of the soundproof booth, each of the two first sleeving structures is one of a sliding sleeve or a guiding bar, and each of the two second sleeving structures is an other of the sliding sleeve or the guiding bar.

Specifically, the wall-mounted adjustable desk further includes a supporting frame 2 for the desk board 1. At least two vertical plates 21 respectively disposed at both sides of the supporting frame 2 in a width direction are connected to a bottom of the desk board 1. Sliding sleeves 22 or guiding bars 3 are disposed at both sides of the supporting frame 2, and guiding bars 3 or sliding sleeves 22 are correspondingly disposed at the wall of the soundproof booth. The guiding bars 3 and the sliding sleeves 22 are engaged in a sliding and sleeving manner. The sliding sleeves 22 may be rectangular sleeves with curved corners and the guiding bars 3 may correspondingly be rectangular tubes with curved corners. In some embodiments, the cross-sections of the sliding sleeves 22 and guiding bars 3 may also be circular, or polygonal, such as triangular, pentagonal, or hexagonal.

In some embodiments, the moving member of the linear driving mechanism 4 may be connected to one side of the supporting frame 2 along its width direction, and at least one vertical plate 21 is provided on the other side of the supporting frame 2 along its width direction. The vertical plate 21 may be connected to at least one of the top, side and bottom of the desk board 1. The sliding sleeve(s) 22 may be provided at the edge or middle of the supporting frame 2, which can slide relative to the guiding bar(s) 3 mounted on the wall, or the guiding bars 3 may be provided at the edge or middle of the supporting frame 2, which can slide relative to the sliding sleeve(s) 22 mounted on the wall.

With the above structures, the wall-mounted adjustable desk of the present application has the following advantages. Since a driving end of the linear driving mechanism is connected to the desk board through the supporting frame, and the supporting frame is provided with the sliding sleeve(s) respectively in sliding fit with corresponding guiding bar(s), the connection between the driving end of the linear driving mechanism and the desk board is firm and has high connection strength. As a result, the guiding performance, flexibility, smoothness, and reliability of the desk board during the adjustments are greatly improved. Therefore, the desk board exhibits good guiding performance, flexibility, smoothness, and reliability during adjustment.

In some embodiments, the wall-mounted adjustable desk further includes a first crossbar and a second crossbar disposed on the wall of the soundproof booth. The first crossbar is configured to be connected to the linear driving mechanism, the first crossbar and the second crossbar are parallel to each other. The linear driving mechanism is configured to be connected to a middle of the first crossbar in a length direction of the first crossbar. Bottom ends of the guiding bars are respectively connected to both ends of the first crossbar in the length direction of the first crossbar, and top ends of the guiding bars are respectively connected to both ends of the second crossbar in a length direction of the second crossbar. The two guiding bars are parallel to each other. With the above structures, the wall-mounted adjustable desk board can be raised and lowered within a certain height range to meet the user's actual needs. Additionally, the structures of height adjustment become more compact to relatively save material costs, and the guiding accuracy, flexibility, smoothness, and reliability of the desk board's lifting movement can be improved.

Specifically, the linear driving mechanism 4 is connected to the middle of the length of the first crossbar 6441 on the wall. The bottom ends of the two guiding bars 3 are respectively connected to both ends of the length of the first crossbar 6441 which is configured to be connected to the linear driving mechanism 4. The top ends of the two guiding bars 3 are connected to both ends of the length of the second crossbar 6442 on the wall. The first crossbar 6441 and the second crossbar 6442 are parallel to each other, and the two guiding bars 3 are parallel to each other. The first crossbar 6441 and the second crossbar 6442 may be rectangular tubes with curved corners.

In some embodiments, the linear driving mechanism 4 may be connected to one end of the first crossbar 6441 in the length direction, the bottom end of at least one guiding bar 3 may be connected to the other end of the first crossbar 6441 in the length direction, and the top end of the at least one guiding bar 3 is connected to the corresponding end of the second crossbar 6442 in the length direction.

In some embodiments, the linear driving mechanism 4 includes a nut-screw rod assembly 41. A motor 42 and a gear box 43 of the linear driving mechanism 4 are mounted on a bottom of the first crossbar 6441. An output shaft 431 of the gear box 43 passes through a hole of the first crossbar 6441 and is coaxially connected to a bottom end of a screw rod of the nut-screw rod assembly 41. A nut of the nut-screw rod assembly 41 is connected to a bottom end of a supporting tube 23, and a part of the supporting tube 23 is connected to a middle part of the supporting frame 2. In some embodiments, the output shaft of the gear box 43 may be connected to the bottom end of a longer hollow screw rod, and a lead screw is provided inside the hollow screw rod, and the top end of the lead screw is fixedly connected to the supporting frame. With the above structures, the moving member of the linear driving mechanism is the nut screwed onto the screw rod of the nut-screw rod assembly, which converts the rotational motion of the screw rod into the linear motion of the nut. Compared with the pushing rod of an electric actuator or similar device serving as the moving member, the linear driving mechanism of the present application provides better stability and reliability, and also makes the connection between the linear driving mechanism and the supporting frame more firm and reliable.

In an implementation, a torsion spring self-locking assembly is provided at a lower end of the screw rod to prevent the desk board from descending when the motor stops and the nut is at a distance from a bottom end of a thread of the screw rod. Specifically, the torsion spring self-locking assembly 44 is provided at the lower end of the screw rod 411 to prevent the desk board 1 from suddenly dropping due to an overload on the desk board 1 when the motor 42 stops and the nut 412 is at a distance from the bottom end of the screw rod 411. A self-locking sleeve 441 with a torsion spring retaining ring 4411 at its top is fitted onto the screw rod 411 below the nut 412. A center hole of the self-locking sleeve 441 is circumferentially and axially limited to the screw rod 411. For example, a waist-shaped hole 4412 is configured to cooperate with the waist-shaped portion 4111 of the screw rod 411. A torsion spring body 4421 of a self-locking torsion spring 442 is interference-fitted onto a circular body 4413 of the self-locking sleeve 441. A bottom of the self-locking torsion spring 442 extends radially outward from the torsion spring body 4421 and is engaged in an engaging groove 4431 of an engaging ring 443 arranged at the top end of a bearing seat 51. The motor 42 drives the screw rod 411 through the gear box 43 to rotate, and when the desk board is being raised, the driving force needs to overcome the spring force of self-locking torsion spring 442. When the motor 42 stops, meaning that the desk board 1 is stationary and the nut 412 is at a distance from the threaded bottom end of screw rod 411, the spring force of self-locking torsion spring 442 grips self-locking sleeve 441 and secures screw rod 411. Even if the weight of the load on desk board 1 exceeds its maximum load-bearing capacity, screw rod 411 will not rotate, preventing the desk board from suddenly lowering due to the rotation of screw rod 411. Therefore, the safety of the wall-mounted adjustable desk can be improved and the user can have a better experience.

A bearing is provided on the lower end of the screw rod and the bearing seat is provided on the first crossbar. Specifically, the bearing 52 such as a rolling bearing and the bearing seat 51 are respectively disposed on the bottom end of the screw rod 411 and the first crossbar 6441. The bearing seat 51 may be a bearing seat of two clamping type half-seat bodies 511 installed on the first crossbar 6441 by multiple installing bolts 512 and multiple installing nuts 513 as sunken nuts. The two clamping type half-seat bodies 511 are aligned and engaged with each other through pin holes and pins 514.

The present application further discloses a soundproof booth, which includes the wall-mounted adjustable desk for a soundproof booth of any one of the above embodiments or implementations. Specifically, the soundproof booth further includes a soundproof door 61, a soundproof bottom panel 62, a soundproof top panel 63, and three soundproof side panels 64 which are configured to form a rectangular soundproof booth body 6. At least one of the three soundproof side panels 64 is configured to be a hollow structure 643 which serves as the wall mentioned in any one of the above embodiments or implementations of the wall-mounted adjustable desk for the soundproof booth. The linear driving mechanism, the supporting frame, the first sleeving structure, and the second sleeving structure of the wall-mounted adjustable desk are mounted on the hollow structure 643. At least two first vertical elongated through holes are correspondingly formed on an inner plate of the hollow structure 643, the inner plate serves as an inner wall of the soundproof booth, the at least two vertical plates connected to the supporting frame pass through the at least first vertical elongated through holes in a one-to-one correspondence. The at least two vertical plates are slidably fitted in the least two first vertical elongated through holes respectively.

Specifically, at least one of the three soundproof side panels 64 is configured to be the hollow structure 643 which includes an inner soundproof plate 641 and an outer soundproof plate 642. Two vertical rods 645 disposed in the hollow structure 643 are connected to a frame of the soundproof booth body 6, and the first crossbar 6441 and the second crossbar 6442 are both connected to both the two vertical rods 645 disposed in the hollow structure 643. The two vertical plates 21 mounted on the supporting frame 2 pass respectively through two first vertical elongated through holes 6411 formed on the inner soundproof plate 641 and are connected to the desk board 1. The two vertical plates 21 are slidably fitted in their respective first vertical elongated through holes 6411.

With the above structures, the soundproof booth equipped with the wall-mounted adjustable desk has the following advantages. Since the linear driving mechanism of the wall-mounted adjustable desk is all arranged inside the hollow structure, and the supporting frame connected with the driving end of the linear driving mechanism is connected with the desk board only through the two vertical plates that pass through the first elongated through holes, the operation noise of the adjustment felt by a person inside the soundproof booth can be relatively small, and most of the structures relative to the adjustments cannot be seen inside the soundproof booth. Therefore, the soundproof booth can be relatively aesthetic and the user's good experience can be improved. In addition, since the linear driving mechanism is connected to the first and the second crossbars, the desk board can move up and down within a certain height range to meet the actual needs of the user, and the structure relative to the adjustment can omit columns outside the screw lead and the increased screw rod length caused by the connection to bottom soundproof panel, thereby relatively saving material cost.

It is not difficult to understand that all the soundproof panels mentioned above may be made of commercially available soundproof materials. Specifically, the panels in this application may include sound-absorbing cotton, metal plates, metal frames and carbon plates from the inside to the outside. And the sound-absorbing cotton and metal plate of the side panel serving as the wall mentioned above are provided with vertical elongated through holes, and the linear driving mechanism, supporting frame, etc. are installed in the hollow area of its metal frame.

Furthermore, the two vertical rods 645 disposed in the hollow structure 643 are connected to the frame of the soundproof booth 6, and the first crossbar 6441 and the second crossbar 6442 are both connected to both the two vertical rods 645. The soundproof booth further includes two elongated plates 7, two second vertical elongated through holes 72 are respectively formed at the two elongated plates 7, and two vertical plates 21 are slidably fitted in the two second vertical elongated through holes 72 respectively. The two second vertical elongated through holes 72 are aligned with the two first vertical elongated through holes 6411 respectively. Each elongated plate 7 includes a protruding strip 71 having a same shape and a same size as the first vertical elongated through holes 6411, and two protruding strips 71 of the two elongated plates 7 are configured to be embedded in the two first vertical elongated through holes 6411 respectively. In addition, the protruding strip 71 may project from the interior surface of the inner soundproof plate 641. The upper and lower ends of the protruding strip 71 of the elongated plates 7 may be rounded ends 73 that match the upper and lower rounded ends of the first vertical elongated through hole 6411. The elongated plates 7 may be made of plastic. The elongated plate 7 may be fixed on the surface of the inner soundproof plate 641 close to the hollow structure 643, i.e., close to the linear driving mechanism 4. The elongated plate 7 can be screwed into the threaded countersunk hole of the elongated plate 7 from the side of the inner soundproof plate 641 away from the desk board 1, or it may be fixed by gluing. With the above structure, the flexibility and reliability of the two vertical plates sliding up and down within the elongated through holes are ensured. Furthermore, both vertical plates can slide vertically within the second vertical elongated through holes of the elongated plate without damaging the inner soundproof plate at the first vertical elongated through holes. The elongated plates provided with the second vertical elongated through holes are plastic elongated plates in the form of protruding strips with rounded ends at both ends. The second vertical elongated through holes are neat, regular, and smooth, and the elongated plate itself is firm, strong, and aesthetically pleasing, thereby further enhancing the user's overall experience.

In some embodiments, an elongated soundproof plate 74 is slidably engaged in each second vertical elongated through hole 72, both side walls of each second vertical elongated through hole 72 are provided with guiding grooves for a sliding of the corresponding elongated soundproof plate. In an implementation, the top of each elongated plate 7 may have a rectangular through hole for the elongated soundproof plate 74 to slide through. In an implementation, the length of the elongated soundproof plate 74 is much greater than that of the second vertical elongated through hole 72. The middle portion of the elongated soundproof plate 74 is connected to the desk board 1 or to each corresponding vertical plate 21. Regardless of the height of the desk board, the elongated soundproof plate 74 can completely cover the second vertical elongated through hole 72. In an implementation, the guiding grooves may also be located on the inner surface of the elongated plate located in the hollow structure. The elongated soundproof plate 74 may be made of soundproof material. By adopting the above structure, not only is the excellent lifting performance of the lifting mechanism ensured, but the noise transmitted into the soundproof booth through the first and second vertical elongated through holes is further reduced. In an implementation, the bottom end of the elongated soundproof plate 74 may be connected to the desk board 1 or the respective vertical plate 21. The elongated soundproof plate 74 is made of soundproof material. It is easy to understand that each second vertical elongated through hole 72 overlaps or is superimposed with its respective first vertical elongated through hole 6411, and the width of the first vertical elongated through hole 6411 may be wider than the width of the second vertical elongated through hole 72. The two vertical plates 21 are slideably fitted within their respective first vertical elongated through holes 6411 and second vertical elongated through holes 72.

In some embodiments, the soundproof booth further includes two L-shaped plates 11. Portions of the two vertical plates 21 under the desk board 1 are detachably connected to the two L-shaped plates 11, and the two L-shaped plates 11 are fixed to a bottom surface of the desk board 1. When the L-shaped plate 11 and the vertical plate 21 of the desk board 1 are connected via multiple bolts and nuts, the height of the desk board 1 away from the inner soundproof plate 641 can be higher, for example, by 1°. This allows the desk board 1 to remain substantially level even with installation errors or normal material deformation.

In this application, the linear driving mechanism may also be an electric pushing rod or cylinder, etc. Specifically, the driving end of the linear driving mechanism may be the free end of the electric pushing rod or the free end of the piston rod of the cylinder, where the electric pushing rod or the cylinder may be fixed on the first crossbar, and a rectangular connecting block may be fixed on the free end of the electric pushing rod or the free end of the piston rod to be connected to the rectangular supporting tube.

The soundproof booth in any of the above embodiments may be an ordinary soundproof booth or a quick-assembly soundproof booth described below.

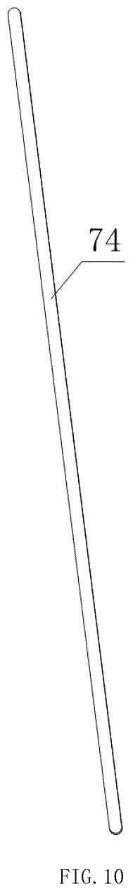

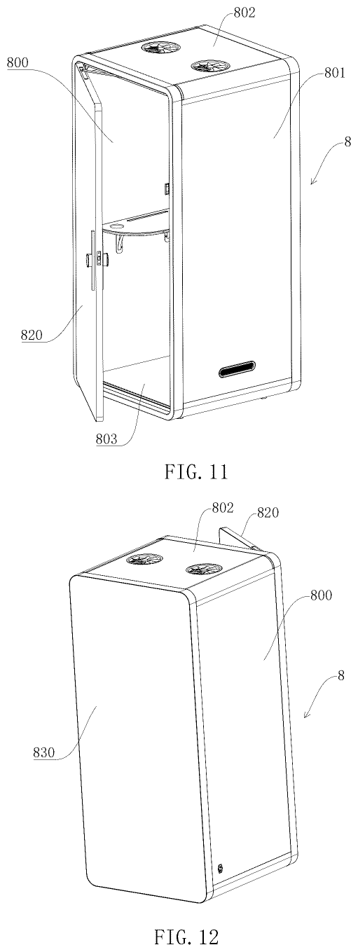

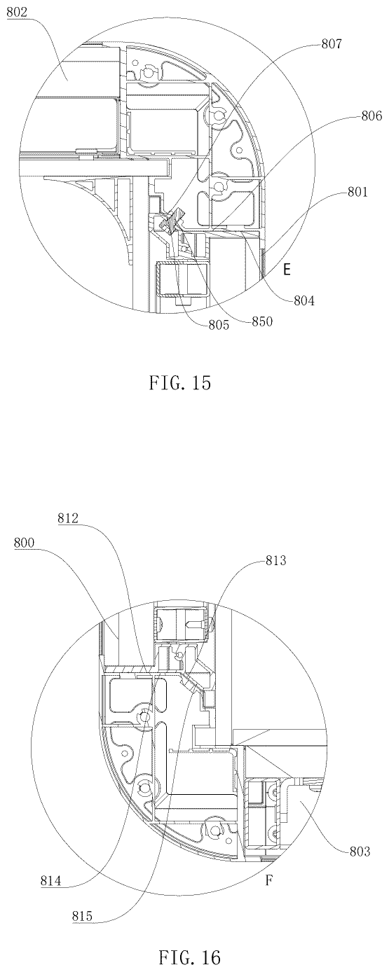

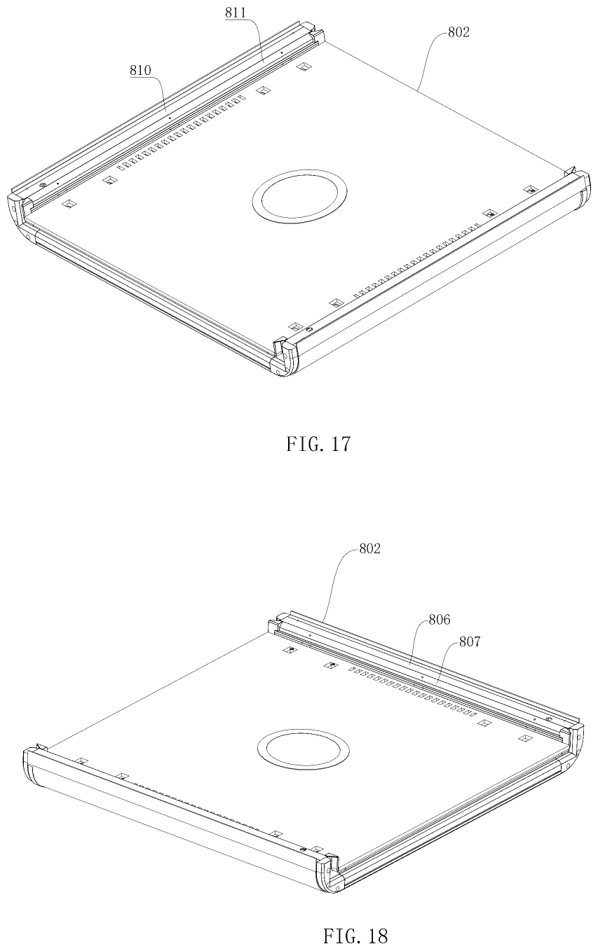

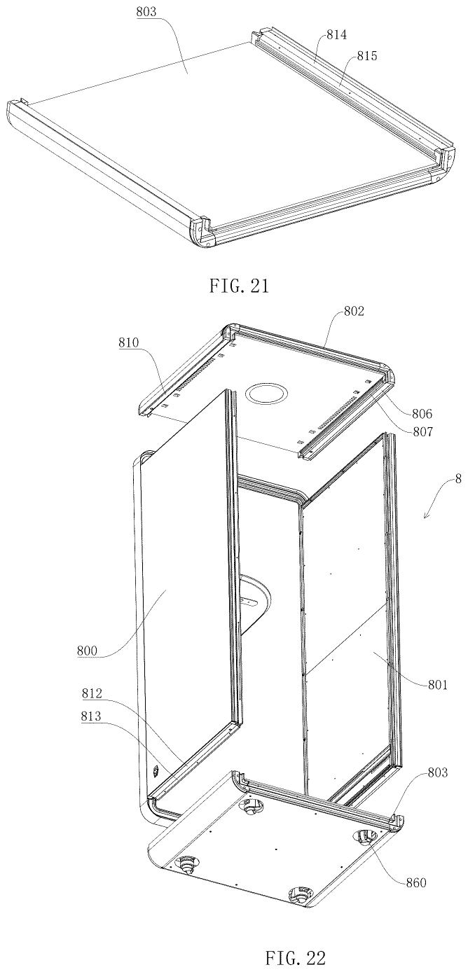

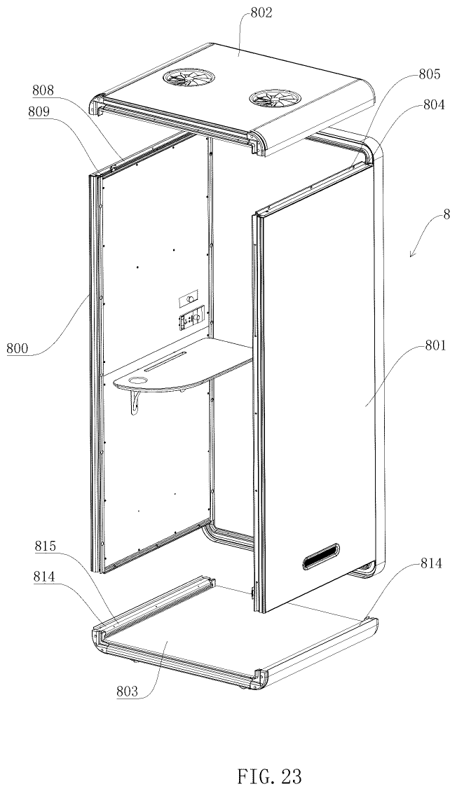

As shown in FIGS. 11 to 26, the present application discloses a quick-assembly soundproof booth, specifically a small soundproof booth for a single person. The quick-assembly soundproof booth includes a bottom assembly 803, a top assembly 802, and two wall panel assemblies. The two wall panel assemblies include a first wall panel assembly 800 and a second wall panel assembly 801. The first wall panel assembly 800 and the second wall panel assembly 801 are arranged parallel to each other. Lower ends of the two wall panel assemblies are respectively connected to the bottom assembly 803, and upper ends of the first wall panel assembly 800 and the second wall panel assembly 801 respectively connected to the top assembly 802. The quick-assembly soundproof booth further includes a back panel assembly 830 and a booth door 820, where the back panel assembly 830 and booth door 820 are arranged opposite each other.

In some embodiments, the quick-assembly soundproof booth can be a bigger booth for multiple people, it is only necessary to increase the number of bottom assemblies, top assemblies, and wall panel assemblies. For example, two bottom assemblies, two top assemblies, two first wall panel assemblies, and two second wall panel assemblies are provided, and each bottom assembly is connected to the lower ends of a set of one first wall panel assembly and one second wall panel assembly, and each top assembly is connected to the upper ends of a set of one first wall panel assembly and one second wall panel assembly.

It is not difficult to understand that the most basic feature of the soundproof booth is sound insulation, so the bottom assembly 803, top assembly 802, wall panel assembly, back panel assembly 830 and booth door 820 of the soundproof booth all serve as soundproof parts of the quick-assembly soundproof booth. Taking the wall panel assembly as an example, its structure generally includes a metal frame, sound insulation material connected to the metal frame, and an outer panel and an inner panel connected to the outside and inside of the metal frame respectively. In order to improve the sound insulation performance, the joints between the soundproof parts are sealed or soundproofed.

It is understood that in order for the quick-assembly soundproof booth to function as intended by the user, it also includes necessary electrical components and furniture. For example, in some embodiment, at least one of a ventilation fan, a desk lamp may be connected to the top assembly 802, a power junction box and a switch may be installed in the wall panel assembly, and a desk may be connected to the inner wall of the wall panel assembly.

The top assembly 802 of the quick-assembly soundproof booth may integrate a ventilation fan, a desk lamp, etc., so it is generally heavy. During the assembly of the soundproof booth in the market, the top assembly needs to be lifted to the upper end of the wall panel assembly. However, it is difficult for a single person to complete the lifting and the operation is relatively laborious. Therefore, in order to facilitate the assembly of the top assembly 802, in some embodiment, as shown in FIGS. 11, 12, 13, 14, 15, 17, 18, 19 and 20, the top assembly 802 includes a first connecting end and a second connecting end opposite to the first connecting end. The first connecting end is rotatably connected to the upper end of the first wall panel assembly 800. In this way, when the booth leaves the factory, the first connecting end of the top assembly 802 has already completed the rotational connection with the upper end of the first wall panel assembly 800. Specifically, the first connecting end of the top assembly 802 is rotatably connected to the upper end of the first wall panel assembly 800 via a pivot 840. During assembly at the construction site, it is only necessary to rotate the top assembly 802 upward to a horizontal state relative to the first wall panel assembly 800 so that the second connecting end of the top assembly 802 can be assembled with the upper end of the second wall panel assembly 801. Therefore, the assembly of the top assembly 802 does not require two or more people to hold up the top assembly 802, and only one person is enough to rotate the top assembly 802 upward to the horizontal state and connect it with the upper end of the second wall panel assembly 801. Therefore, the assembly of the top assembly 802 is very labor-saving and simple.

In some embodiments, an upper end of the second wall panel assembly 801 has a first mounting surface 804, and the matching surface shape between the second connecting end of the top assembly 802 and the first mounting surface 804 may be a combined surface shape of a horizontal surface and an inclined surface. Specifically, as shown in FIGS. 15, 17, 18, and 19, the upper end of the second wall panel assembly 801 has a horizontally disposed first mounting surface 804 and a first connecting surface 805 located inside the first mounting surface 804, and the first connecting surface 805 is inclined relative to the first mounting surface 804. The second connecting end of the top assembly 802 has a horizontally disposed second mounting surface 806 and a second connecting surface 807 inclined relative to the second mounting surface 806. When the top assembly 802 is rotated upward to the horizontal state relative to the first wall panel assembly 800, the second mounting surface 806 of the top assembly 802 can be matched with and connected to the first mounting surface 804 of the second wall panel assembly 801, and the second connecting surface 807 of the top assembly 802 can be matched with and connected to the first connecting surface 805 of the second wall panel assembly 801. Therefore, the matching surface shape between the second connecting end of the top assembly 802 and the first mounting surface 804 is a combination of a horizontal surface and an inclined surface.

Furthermore, in some embodiments, the second connecting end of the top assembly 802 is matched with and connected to the first mounting surface at the upper end of the second wall panel assembly 801 by one or more fasteners 850. The fastener 850 may be at least one of a screw, bolt, rivet or fastening pin, etc.

It is not difficult to understand that when the fastener connects two inclined connecting surfaces, the fastener is fastened in a direction perpendicular to the connecting surfaces, so the fastener is also arranged at an angle.

It is understood that in the above embodiment, the inclined and mutually abutting first connecting surface 805 and second connecting surface 807 inevitably increase the contacting area between the top assembly 802 and the upper end of the second wall panel assembly 801, thereby improving the stability and sealing effect of the connection between the top assembly 802 and the wall panel assembly. In addition, the inclined and mutually abutting first connecting surface 805 and second connecting surface 807 are connected by fastener 850, thereby increasing the distance between fastener(s) 850 and the top assembly 802 or the wall panel assembly. In addition, the inclined setting of fastener 850 makes the tightening operation more convenient and labor-saving, and can ensure that fastener 850 is firmly installed, thereby ensuring a firm, stable connection between the top assembly 802 and the wall panel assembly with good sealing performance. The second connecting surface 807 on the top assembly 802 and the first connecting surface 805 on the second wall panel assembly 801 are both inclined. Under the action of the gravity of the top assembly 802 and the locking force of the fastener 850, the locking between the top assembly 802 and the second wall panel assembly 801 is more secure and stable.

In some embodiments, the matching surface shape between the second connecting end of the top assembly and the first mounting surface of the second wall panel assembly may be an inclined surface shape, that is, the second mounting surface of the second connecting end of the top assembly is an inclined surface and the first mounting surface is an inclined surface matching it. This increases the contacting area between the top assembly and the upper end of the second wall panel assembly, thereby ensuring good connection stability and sealing effect between the top assembly and the wall panel assembly.

In some embodiments, the matching surface shape between the second connecting end of the top assembly and the first mounting surface of the second wall panel assembly may be a combined surface shape of a horizontal surface and an arc surface. Specifically, the first connecting surface and the second connecting surface may be set as arc surfaces respectively, and the two can be matched with each other. The contacting area between the top assembly and the upper end of the second wall panel assembly is also increased, so that the connection between the top assembly and the wall panel assembly is stable and has a good sealing effect.

In some embodiments, the fitting surface between the second connecting end of the top assembly and the first mounting surface of the second wall panel assembly may be a stepped surface. Specifically, the first connecting surface may be set as a plane surface parallel to the first mounting surface and with a height higher or lower than the first mounting surface. Similarly, the second connecting surface may be set as a plane surface parallel to the second mounting surface and with a height lower or higher than the second mounting surface. When the second connecting end of the top assembly is joined to the upper end of the second wall panel assembly, the matching surface shape between the two is a stepped surface shape, which also increases the contacting area between the top assembly and the upper end of the second wall panel assembly, thereby ensuring good connection stability and sealing effect between the top assembly and the wall panel assembly.

In some embodiments, the second connecting end of the top assembly and the first mounting surface of the second wall panel assembly may also be connected by adhesive material, making the connection between the two more convenient, firm and stable. The adhesive material is an adhesive or glue that can bond metal materials together.

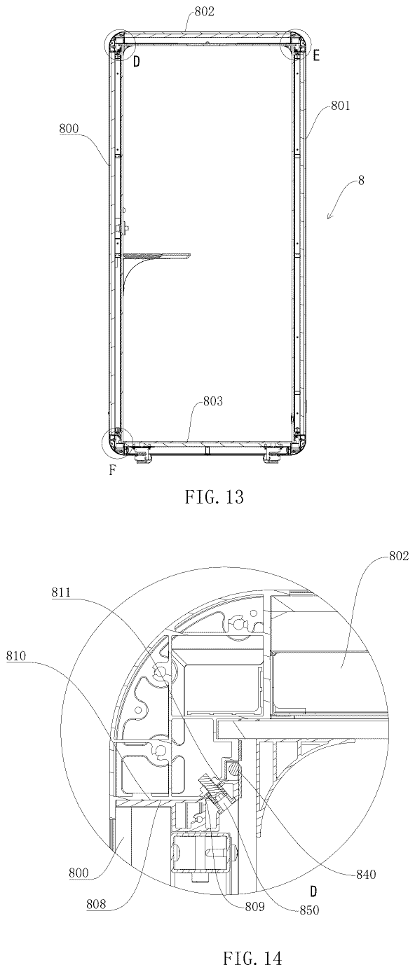

Furthermore, as shown in FIGS. 13, 14, 17 and 19, the upper end of the first wall panel assembly 800 has a third mounting surface 808 and a third connecting surface 809 located on the inner side of the third mounting surface 808, and the third connecting surface 809 is inclined relative to the third mounting surface 808. The first connecting end of the top assembly 802 has a fourth mounting surface 810 and a fourth connecting surface 811 inclined relative to the fourth mounting surface 810. When the top assembly 802 is rotated to the horizontal state, the fourth mounting surface 810 is configured to be matched with the third mounting surface 808 and the fourth connecting surface 811 is configured to be matched with the third connecting surface 809, and the third connecting surface 809 and the fourth connecting surface 811 are configured to be connected by fasteners 5. That is, between the first connecting end of the top assembly 802 and the upper end of the first wall panel assembly 800, there are also provided the third connecting surface 809 and the fourth connecting surface 811 that are inclined and able to be matched with each other. When the top assembly 802 is rotated to the horizontal state, the fourth connecting surface 811 of the top assembly 802 is just matched with the third connecting surface 809 of the first wall panel assembly 800 and then fastened together by the fastener(s) 850. In other words, the first connecting end of the top assembly 802 and the upper end of the first wall panel assembly 800, as well as the second connecting end of the top assembly 802 and the upper end of the second wall panel assembly 801, are matched by inclined connecting surfaces and connected by fasteners, so that the connection between the two connecting ends of the top assembly 802 and the upper ends of the two wall panel assemblies is more firm and stable.

In some embodiments, the structure of the upper end of the first wall panel assembly 800 is symmetrically arranged with the structure of the upper end of the second wall panel assembly 801, and the structures of the first connecting end and the second connecting end of the top assembly 802 are symmetrically arranged. That is, the third mounting surface 808 and the third connecting surface 809 at the upper end of the first wall panel assembly 800 are respectively symmetrical with the first mounting surface 804 and the first connecting surface 805 at the upper end of the second wall panel assembly 801. The second mounting surface 806 and the second connecting surface 807 at the second connecting end of the top assembly 802 are respectively symmetrical with the fourth mounting surface 810 and the fourth connecting surface 811 of the first connecting end of the top assembly 802.

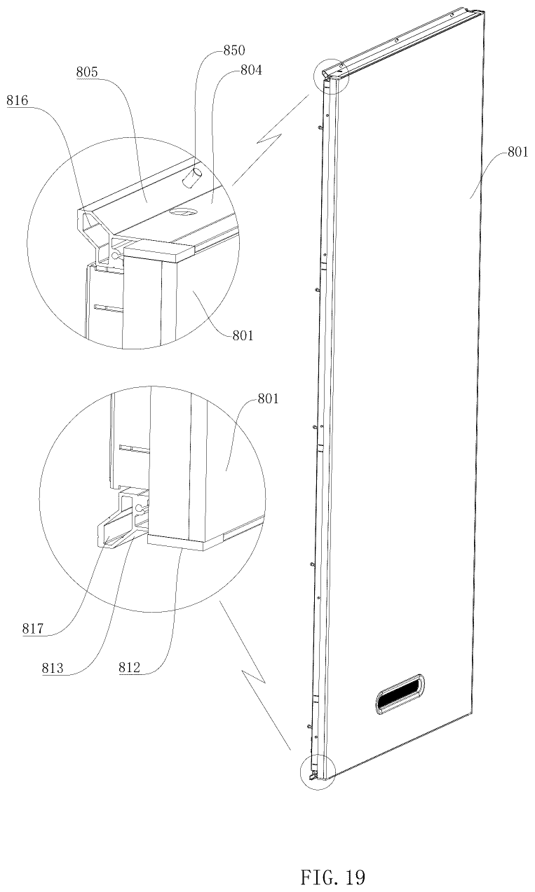

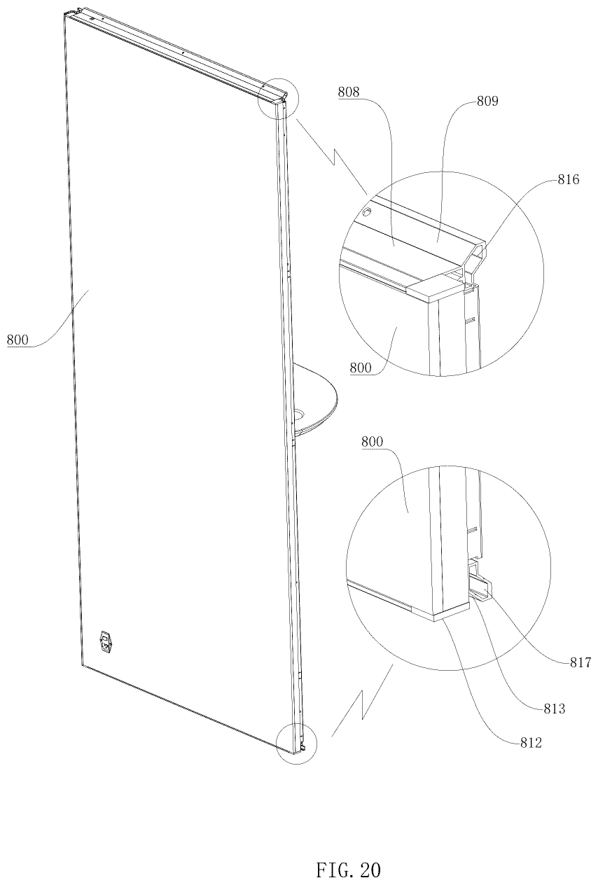

Specifically, in some embodiments, as shown in FIGS. 19 and 20, a first connecting portion 816 is provided on the inner side of the upper end of each wall panel assembly along the length direction, the first connecting portion 816 is inclined toward the center of the top assembly 802. The outer sidewall of the first connecting portion 816 of the second wall panel assembly 801 forms the first connecting surface 805, and the outer sidewall of the first connecting portion 816 of the first wall panel assembly 800 forms the third connecting surface 809. It is understood that the side of the first connecting portion 816 facing away from the connecting surface, that is, the inner sidewall of the first connecting portion 816, is inclined. When fastener 850 is connected, it passes through the first connecting portion 816 from the inside to the outside and is connected to the connecting end of the top assembly 802. This not only facilitates the tightening operation of the fastener 850, but also, the inclined connecting surface is tightened by the tightening force of the fastener 850, thereby achieving a stable connection between the top assembly 802 and the wall panel assembly and improving the sound insulation effect.

As shown in FIGS. 19, 20, 21, 22, and 23, the lower end of each wall panel assembly has a fifth mounting surface 812 and a fifth connecting surface 813 located inside and inclined relative to the fifth mounting surface 812. The ends of the bottom assembly 803 are respectively provided with a sixth mounting surface 814 and a sixth connecting surface 815 inclined relative to the sixth mounting surface 814. When the lower end of the wall panel assembly is connected to the bottom assembly 803, the fifth mounting surface 812 abuts the sixth mounting surface 814, and the fifth connecting surface 813 abuts the sixth connecting surface 815. The fifth connecting surface 813 and the sixth connecting surface 815 are connected by fasteners 5. The cooperation between the fifth connecting surface 813 at the lower end of each wall panel assembly and the sixth connecting surface 815 of the bottom assembly 803 increases the contacting area between the bottom assembly 803 and the wall panel assembly, thereby making the connection between the two more secure and stable.

Specifically, in some embodiments, a second connecting portion 817 is provided along the length of the inner side of the lower end of each wall panel assembly, the second connecting portion 817 is inclined toward the center of the bottom assembly 803. The outer sidewall of the second connecting portion 817 of each wall panel assembly forms a fifth connecting surface 813. It will be appreciated that the connection structure between the bottom assembly 803 and the lower end of the wall panel assembly is similar to the connection structure between the top assembly 802 and the upper end of the wall panel assembly. Both are secured by the cooperation of the inclined, mutually abutting connecting surfaces and the fasteners 5. Consequently, the structure of the main booth body 8, which is formed by the bottom assembly 803, the top assembly 802, and the two wall panel assemblies, is highly stable.

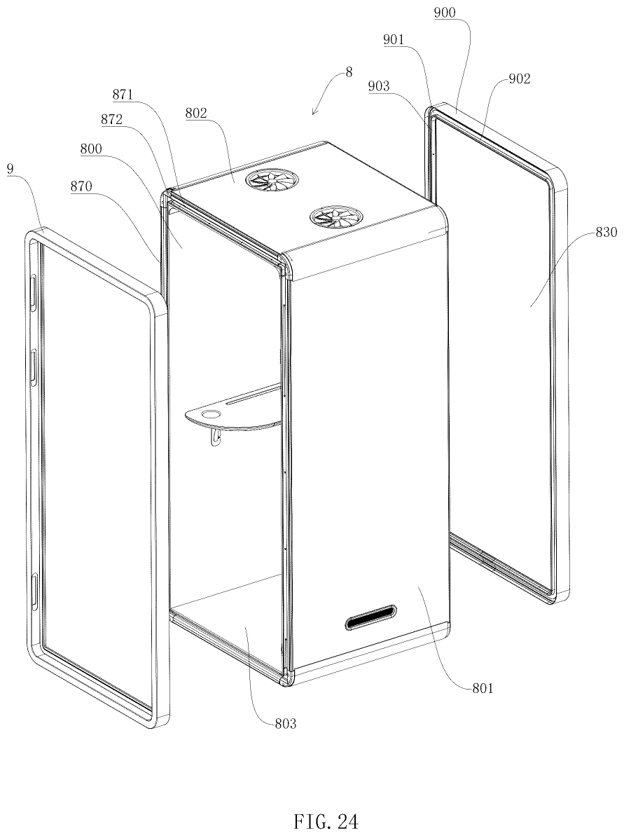

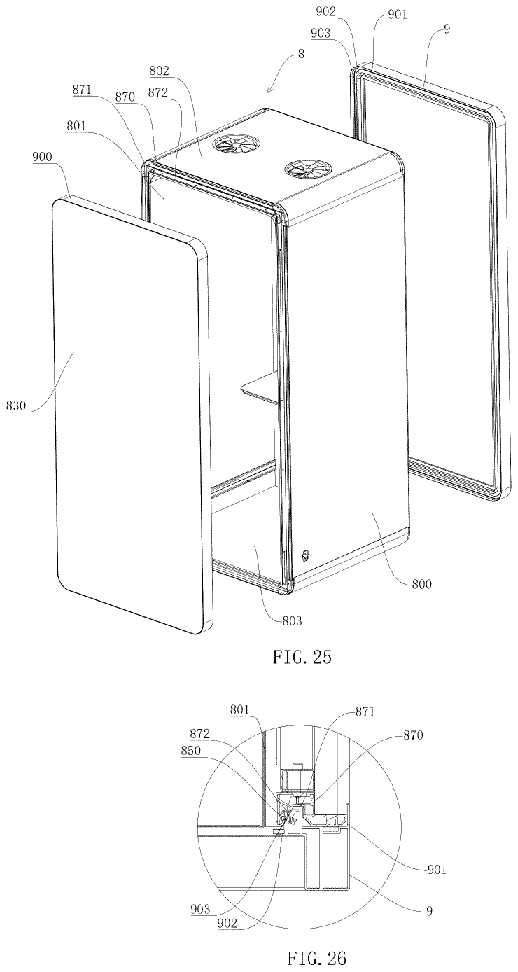

In some embodiments, as shown in FIGS. 24 and 25, the main booth body 8, formed by a bottom assembly 803, a top assembly 802, and two wall panel assemblies, is enclosed. A front frame 9 is connected to the front side of the main booth body 8, while a rear frame 900 is connected to the rear side of the main booth body 8. The booth door 820 configured to open and close the soundproof booth is connected to the front frame 9, and a back panel assembly 830 is connected to the rear frame 900. The arrangements of the front frame 9 and rear frame 900 improve the sealing performance of the front and rear sides of the main booth body 8. Specifically, connecting frames 870 are connected to the front and rear side walls of the main booth body 8, respectively. The front frame 9 and the rear frame 900 are circumferentially provided with two plug-in slots 901 respectively. The plug-in slot 901 on the front frame 9 is configured to be plugged in and connected to the connecting frame 870 on the front side wall of the main booth body 8, and the plug-in slot 901 on the rear frame 900 is configured to be plugged in and connected to the connecting frame 870 on the rear side wall of the main booth body 8. The connecting frames 870 located at the front or the rear side of the main booth body 8 are both ring-shaped and made of profiles. They not only seal the bottom assembly 803, the top assembly 802 and the sides of the two wall panels, but also facilitate the installation of the front frame 9 and the rear frame 900.

Furthermore, as shown in FIGS. 25 and 26, the connecting frames 870 is provided with a mounting slot 871 which is concave and extend along the length direction, and at least one inner side wall of each mounting slot 871 is inclined to form a first mounting inclined surface 872. Two mounting member 902 are respectively disposed in the two plug-in slots 901 of the front frame 9 and the rear frame 900, and the mounting slot 871 and the mounting member 902 are arranged correspondingly and configured to match each other. Each mounting member 902 is provided with a second mounting inclined surface 903 matching with the first mounting inclined surface 872, and the first mounting inclined surface 872 and the second mounting inclined surface 903 are connected by the fastener(s) 850.

In an implementation, taking the assembly of the front frame 9 as an example, the plug-in slot 901 of the front frame 9 is plugged or sleeved on the connecting frame 870 on the front side of the main booth body 8. Meanwhile, the mounting member 902 of the front frame 9 is fitted in the mounting slot 871 of the connecting frame 870, and the second mounting inclined surface 903 on the mounting member 902 is fitted with the first mounting inclined surface 872 in the mounting slot 871, and then the first mounting inclined surface 872 and the second mounting inclined surface 903 are connected by the fasteners 850. The assembly of the rear frame 900 is also the same, which will not be repeated; it can be understood that the connection of the front frame 9 and the rear frame 900 is also achieved by matching the inclined surfaces and then locking them with the fasteners 850, so that the assembly of the front frame 9 and the rear frame 900 is simple, convenient, and labor-saving, and the connection is highly firm.

In some embodiments, in order to facilitate the movement of the quick-assembly soundproof booth, as shown in FIG. 22, wheels 860 are connected to the bottom of the bottom assembly 803 of the quick-assembly soundproof booth.

In the description of the embodiments of the present application, it should be noted that in the description of the present application, terms such as “inside” and “outside” indicating directions or positional relationships are based on the directions or positional relationships shown in the accompanying drawings. This is only for the convenience of description and does not indicate or imply that the device or component must have a specific orientation, be constructed and operated in a specific orientation. Therefore, it cannot be understood as a limitation on the present application.

In the description of the present application, the description with reference to the terms “one embodiment”, “some embodiments”, “in one implementation”, “for example”, or “some implementations” means that the specific features, mechanisms, materials or characteristics described in conjunction with the embodiment or example are included in at least one embodiment or example of the present application. In this specification, the schematic representations of the above terms do not necessarily refer to the same embodiment or example. Moreover, the specific features, mechanisms, materials or characteristics described can be combined in a suitable manner in any one or more embodiments or examples. In addition, those skilled in the art can combine different embodiments or examples described in this specification and the features of different embodiments or examples, unless they are contradictory.

The above description is merely a specific embodiment of the present application, but the scope of protection of the present application is not limited thereto. Any changes or substitutions that can be easily conceived by a person skilled in the art within the technical scope disclosed in the present application should be included in the scope of protection of the present application. Therefore, the scope of protection of the present application should be based on the scope of protection of the claims.

What is claimed is:

1. A wall-mounted adjustable desk for a soundproof booth, comprising:
a desk board;
a linear driving mechanism mounted on a wall of the soundproof booth; and
a supporting frame for the desk board, wherein a moving member of the linear driving mechanism is connected to the supporting frame, the supporting frame is connected to the desk board, the supporting frame is provided with a first sleeving structure, and the wall of the soundproof booth is provided with a second sleeving structure slidably engaged with the first sleeving structure in a sleeving manner.

2. The wall-mounted adjustable desk for the soundproof booth according to claim 1, wherein at least two vertical plates respectively disposed at both sides of the supporting frame in a width direction are connected to a bottom of the desk board, and two first sleeving structures are disposed at both sides of the supporting frame, and two second sleeving structures are correspondingly disposed on the wall of the soundproof booth, each of the two first sleeving structures is one of a sliding sleeve or a guiding bar, and each of the two second sleeving structures is an other of the sliding sleeve or the guiding bar.

3. The wall-mounted adjustable desk for the soundproof booth according to claim 2, further comprising a first crossbar and a second crossbar disposed on the wall of the soundproof booth, wherein the first crossbar is configured to be connected to the linear driving mechanism, the first crossbar and the second crossbar are parallel to each other, the linear driving mechanism is configured to be connected to a middle of the first crossbar in a length direction of the first crossbar, bottom ends of the guiding bars are respectively connected to both ends of the first crossbar in the length direction of the first crossbar, top ends of the guiding bars are respectively connected to both ends of the second crossbar in a length direction of the second crossbar, and the two guiding bars are parallel to each other.

4. The wall-mounted adjustable desk for the soundproof booth according to claim 3, wherein the linear driving mechanism comprises a nut-screw rod assembly, a motor and a gear box of the linear driving mechanism are mounted on a bottom of the first crossbar, an output shaft of the gear box passes through a hole of the first crossbar and is coaxially connected to a bottom end of a screw rod of the nut-screw rod assembly, a nut of the nut-screw rod assembly is connected to a bottom end of a supporting tube, and a part of the supporting tube is connected to a middle part of the supporting frame.

5. The wall-mounted adjustable desk for the soundproof booth according to claim 4, wherein a torsion spring self-locking assembly is provided at a lower end of the screw rod to prevent the desk board from descending when the motor stops and the nut is at a distance from a bottom end of a thread of the screw rod.

6. The wall-mounted adjustable desk for the soundproof booth according to claim 4, wherein a bearing is provided on the lower end of the screw rod and a bearing seat is provided on the first crossbar.

7. A soundproof booth, comprising the wall-mounted adjustable desk for a soundproof booth according to claim 3, wherein the soundproof booth further comprises a soundproof door, a soundproof bottom panel, a soundproof top panel, and three soundproof side panels which are configured to form a rectangular soundproof booth body, at least one of the three soundproof side panels being configured to have a hollow structure;
wherein the soundproof side panel with the hollow structure serves as the wall of the soundproof booth, and the linear driving mechanism, the supporting frame, the first sleeving structure, and the second sleeving structure of the wall-mounted adjustable desk are mounted on the soundproof side panel with the hollow structure; and
wherein at least two first vertical elongated through holes are correspondingly formed on an inner plate of the hollow structure, the inner plate serves as an inner wall of the soundproof booth, the at least two vertical plates connected to the supporting frame pass through the at least first vertical elongated through-holes in a one-to-one correspondence, and the at least two vertical plates are slidably fitted in the at least two first vertical elongated through holes respectively.

8. The soundproof booth according to claim 7, wherein two vertical rods disposed in the hollow structure are connected to a frame of the soundproof booth, and the first crossbar and the second crossbar are both connected to the two vertical rods; the soundproof booth further comprises two elongated plates, two second vertical elongated through holes are respectively formed at the two elongated plates, and two vertical plates are slidably fitted in the two second vertical elongated through holes respectively, the two second vertical elongated through holes are aligned with the two first vertical elongated through holes respectively;
each elongated plate comprises a protruding strip having a same shape and a same size as the first vertical elongated through holes, two protruding strips of the two elongated plates are configured to be embedded in the two first vertical elongated through holes respectively.

9. The soundproof booth according to claim 8, wherein an elongated soundproof plate is slidably engaged in each second vertical elongated through hole, both side walls of each second vertical elongated through hole are provided with guiding grooves for a sliding of the elongated soundproof plate.

10. The soundproof booth according to claim 8, further comprising two L-shaped plates, wherein portions of the two vertical plates under the desk board are detachably connected to the two L-shaped plates, and the two L-shaped plates are fixed to a bottom surface of the desk board.
